(19) United States
(12) Patent Application Publication
(10) Pub. No.: US 2015/0304681 A1
(43) Pub. Date: Oct. 22, 2015

(54) METHOD AND APPARATUS OF INTER-VIEW MOTION VECTOR PREDICTION AND DISPARITY VECTOR PREDICTION IN 3D VIDEO CODING

(71) Applicant: MEDIATEK Singapore Pte. Ltd., Singapore (SG)

(72) Inventors: Jicheng An, Beijing (CN); Yi-Wen Chen, Taichung (TW); Jian-Liang Lin, Yilan County (TW); Shaw-Min Lei, Hsinchu County (TW)

(21) Appl. No.: 14/411,375

(22) PCT Filed: May 20, 2013
(86) PCT No.: PCT/CN2013/075894

§ 371 Date: Dec. 24, 2014

(30) Foreign Application Priority Data
Jul. 3, 2012 (CN) PCT/CN2012/078103

(51) Int. Cl. H04N 19/513; H04N 19/139; H04N 19/172; H04N 19/124; H04N 19/167; H04N 19/103; H04N 19/176

(52) U.S. Cl. CPC H04N 19/521; H04N 19/103; H04N 19/139; H04N 19/176; H04N 19/124; H04N 19/167; H04N 19/172

(57) ABSTRACT

A method and apparatus for deriving inter-view candidate for a block in a picture for three-dimensional video coding are disclosed. Embodiments of the present invention derive the inter-view candidate from an inter-view collocated block in an inter-view picture corresponding to the current block of the current picture, wherein the inter-view picture is an inter-view reference picture and wherein the inter-view reference picture is in a reference picture list of the current block. The derived inter-view candidate is then used for encoding or decoding of the current motion vector or disparity vector of the current block. One aspect of the invention addresses re-use of the motion information of the inter-view collocated block. Another aspect of the invention addresses constrains on the inter-view picture that can be used to derive the inter-view candidate.

### CROSS REFERENCE TO RELATED APPLICATIONS

The present invention claims priority to PCT Patent Application, Serial No. PCT/CN2012/078103, filed Jul. 3, 2012, entitled “Methods to improve and simplify inter-view motion vector prediction and disparity vector prediction”. The PCT Patent Applications is hereby incorporated by reference in its entirety.

### FIELD OF INVENTION

The present invention relates to three-dimensional video coding. In particular, the present invention relates to derivation of motion vector prediction and disparity vector prediction for inter-view candidate in 3D video coding.

### BACKGROUND OF THE INVENTION

Three-dimensional (3D) television has been a technology trend in recent years that intends to bring viewers sensational viewing experience. Various technologies have been developed to enable 3D viewing. The multi-view video is a key technology for 3DTV application among others. The traditional video is a two-dimensional (2D) medium that only provides viewers a single view of a scene from the perspective of the camera. However, the multi-view video is capable of offering arbitrary viewpoints of dynamic scenes and provides viewers the sensation of realism.

The multi-view video is typically created by capturing a scene using multiple cameras simultaneously, where the multiple cameras are properly located so that each camera captures the scene from one viewpoint. Accordingly, the multiple cameras will capture multiple video sequences corresponding to multiple views. In order to provide more views, more cameras have been used to generate multi-view video with a large number of video sequences associated with the views. Accordingly, the multi-view video will require a large storage space to store and/or a high bandwidth to transmit. Therefore, multi-view video coding techniques have been developed in the field to reduce the required storage space or the transmission bandwidth.

A straightforward approach may be to simply apply conventional video coding techniques to each single-view video sequence independently and disregard any correlation among different views. For example, FIG. 1 illustrates straightforward implementation of 3D video coding based on conventional video coding, where a standard conforming video coder (e.g., HEVC/H.264) is used for the base-view video. The incoming 3D video data consists of images (110-0, 110-1, 110-2, . . . ) corresponding to multiple views. The images collected for each view form an image sequence for the corresponding view. Usually, the image sequence 110-0 corresponding to a base view (also called an independent view) is coded independently by a video coder 130-0 conforming to a video coding standard such as H.264/AVC or HEVC (High Efficiency Video Coding). The video coders (130-1, 130-2 . . . ) for image sequences associated with the dependent views (i.e., views 1, 2, . . . ) may also be based on conventional video coders.

In order to support interactive applications, depth maps (120-0, 120-1, 120-2, . . . ) associated with a scene at respective views are also included in the video bitstream. In order to reduce data associated with the depth maps, the depth maps are compressed independent using depth map coder (140-0, 140-1, 140-2, . . . ) and the compressed depth map data is included in the bit stream as shown in FIG. 1. A multiplexer 150 is used to combine compressed data from image coders and depth map coders. The depth information can be used for synthesizing virtual views at selected intermediate viewpoints. The 3D video coding system as shown in FIG. 1 is conceptually simple and straightforward. However, the compression efficiency will be poor.

Various techniques to improve the coding efficiency of 3D video coding have been disclosed in the field. There are also development activities to standardize the coding techniques. For example, a working group, ISO/IEC JTC1/SC29/WG11 within ISO (International Organization for Standardization) is developing an HEVC based 3D video coding standard. In the reference software for HEVC based 3D video coding Version 3.1 (HTM3.1), inter-view candidate is added as a motion vector (MV)/disparity vector (DV) candidate for Inter, Merge and Skip mode, where the inter-view candidate is based on previously encoded motion information of adjacent views. In HTM3.1, the basic unit for compression, termed coding unit (CU), is a 2N×2N square block and each CU can be recursively partitioned into four smaller CUs until the predefined minimum size is reached. Each CU contains one or multiple prediction units (PUs). In the remaining parts of this document, the used term “block” is equal to PU when the underlying processing is associated with prediction.

FIG. 2 illustrates exemplary prediction structure used in common test conditions for 3D video coding. The video pictures and depth maps corresponding to a particular camera position are indicated by a view identifier (i.e., V0, V1 and V2 in FIG. 2). All video pictures and depth maps that belong to the same camera position are associated with a same viewId. The view identifiers are used for specifying the coding order inside the access units and detecting missing views in error-prone environments. Within an access unit (e.g., access unit 210), the video picture (212) and the associated depth map, if present, with viewId equal to 0 are coded first. The video picture and the depth map associated with viewID equal to 0 are followed by the video picture (214) and depth map with viewId equal to 1, the video picture (216) and depth map with viewID equal to 2 and so on. The view with viewId equal to 0 (i.e., V0 in FIG. 2) is also referred to as the base view or the independent view. The base view is independently coded using a conventional HEVC video coder without the need of any depth map and without the need of video pictures from any other view.

As shown in FIG. 2, motion vector predictor (MVP)/disparity vector predictor (DVP) can be derived from the inter-view blocks in the inter-view pictures for the current block. In the following, “inter-view blocks in inter-view picture” may be abbreviated as “inter-view blocks” and the derived candidate is termed as inter-view candidates (i.e., inter-view MVPs/ DVPs). Moreover, a corresponding block in a neighboring view, also termed as an inter-view collocated block, is determined by using the disparity vector derived from the depth information of the current block in the current picture. For example, current block 226 in current picture 216 in view V2 is being processed. Block 222 and block 224 are located in the inter-view collocated pictures 0 and 1 (i.e., 212 and 214) respectively at the corresponding location of current block 226. Corresponding blocks 232 and 234 (i.e., inter-view collocated blocks) in the inter-view collocated pictures 0 and 1 (i.e., 212 and 214) can be determined by the disparity vectors 242 and 244 respectively.

Assuming that the view coding order starts with V0 (base view) followed by V1 and then V2. When a current block in a current picture in V2 is coded, the MVP/DVP derivation process will first check if the MV of the corresponding block in V0 is valid and available. If yes, this MV will be added into the candidate list. If not, the MVP/DVP derivation process will continue to check the MV of the corresponding block in V1.

In HTM3.1, the Merge inter-view MVP/DVP candidate derivation is shown in Algorithm 1 as follows:

Algorithm 1: Merge inter-view candidate derivation
1. For the temporal reference picture with the smallest reference index in List 0, derive the MV according to Algorithm 2;
2. For the temporal reference picture with the smallest reference index in List 1, derive the MV according to Algorithm 2;
3. If one or two of the above two reference pictures have valid MVs, go to step 6;
Else, go to step 4;
4. For other reference pictures in List 0, check these pictures in List 0 according to the reference index in the ascending order and derive the MV/DV according to Algorithm 2 for a given reference picture in List 0. Once a valid MV/DV for the given reference picture is derived, then go to step 5.
5. For other reference pictures in List 1, check these pictures in List 1 according to the reference index in the ascending order and derive the MV/DV according to Algorithm 2 for a given reference picture in List 1. Once a valid MV/DV for the given reference picture is derived, then go to step 6.
6. Done.

Algorithm 2 is described as follows:

Algorithm 2: Given the reference picture, the derivation of Merge inter-view candidate for the current block is as follows.
1. If the reference picture is a temporal reference picture, then from V0 to a previous coded view, the first MV of the inter-view block pointing to the reference picture is used.
2. If the reference picture is an inter-view reference picture, the disparity vector is derived from the depth map.

The Merge inter-view candidate is then included in MVP/DVP for predictive coding of the MV of the current block. If the Merge inter-view candidate selected provides very good match with the motion vector (or disparity vector) of the current block, the prediction residue will be zero. It does not need to transmit the prediction residue between the selected Merge inter-view candidate and the motion vector (or disparity vector) of the current block. In this case the current block may re-use the motion vector (or disparity vector) of the selected Merge inter-view candidate. In other words, the current block can be “merged” with the selected inter-view collocated block. This will reduce required bandwidth associated with the motion vector of the current block. The Merge inter-view candidate derivation in the existing approach, i.e., HTM3.1, is very computationally intensive. It is desirable to simplify the derivation process while retaining coding efficiency as much as possible.

### SUMMARY OF THE INVENTION

A method and apparatus for deriving inter-view candidate for a block in a picture for three-dimensional video coding are disclosed. Embodiments of the present invention derive the inter-view candidate from an inter-view collocated block in an inter-view picture corresponding to the current block of the current picture, wherein the inter-view picture is an inter-view reference picture and wherein the inter-view reference picture is in a reference picture list of the current block. The derived inter-view candidate is then used for encoding or decoding of the current motion vector or disparity vector of the current block.

The location of the inter-view collocated block can be determined based on the disparity vector derived from a depth map or a global disparity vector. The motion information of the inter-view collocated block can be re-used directly by the current block of the current picture, wherein the motion information comprises motion vectors, prediction direction, identification of the inter-view reference picture of the inter-view collocated block, and any combination thereof, and wherein the prediction direction includes reference picture List 0, reference picture List 1 or bi-prediction. One aspect of the invention addresses re-use of the motion information of the inter-view collocated block. The motion information can be scaled to a target reference picture of the current block if reference picture of the inter-view block is not in the reference picture list of the current block. The target reference picture is the reference picture that the motion vector of the current block points to. The target reference picture can be a temporal reference picture with the smallest reference picture index, a temporal reference picture corresponding to a majority of the temporal reference pictures of spatially neighboring blocks of the current block, or a temporal reference picture with a smallest POC (Picture Order Count) distance to the reference picture of the inter-view collocated block.

Another aspect of the invention addresses constrains on the inter-view picture that can be used to derive the Merge inter-view candidate. In one embodiment, only one inter-view picture is used to derive the Merge inter-view. For example, only an inter-view reference picture in reference picture List 0 with a smallest reference picture index is used to derive the inter-view candidate. If no inter-view reference picture exists in reference picture List 0, only the inter-view reference picture in reference picture List 1 with a smallest reference picture index is used to derive the inter-view candidate. In another embodiment, only an inter-view reference picture with a smallest view index is used to derive the inter-view candidate. One syntax element can be used to indicate which inter-view reference picture is used to derive the inter-view candidate. In yet another embodiment, one syntax element is signaled to indicate which reference picture list corresponding to the inter-view reference picture is used to derive the inter-view candidate. In yet another embodiment, only the inter-view picture in a decoded picture buffer or in the base view is used to derive the inter-view candidate.

### BRIEF DESCRIPTION OF THE DRAWINGS

FIG. 1 illustrates an example of prediction structure for a three-dimensional video coding system.

FIG. 2 illustrates an exemplary prediction structure used in the common test conditions for three-dimensional (3D) video coding.

FIGS. 3A-B illustrate examples of Merge inter-view candidate derivation according to an algorithm disclosed in High Efficiency Video Coding (HEVC) based 3D video coding Version 3.1 (HTM3.1).

FIGS. 4A-B illustrate examples of Merge inter-view candidate derivation according to an embodiment of the present invention.

FIG. 5 illustrates an exemplary flowchart of a three-dimensional coding system incorporating an embodiment of the present invention to derive Merge inter-view candidate.

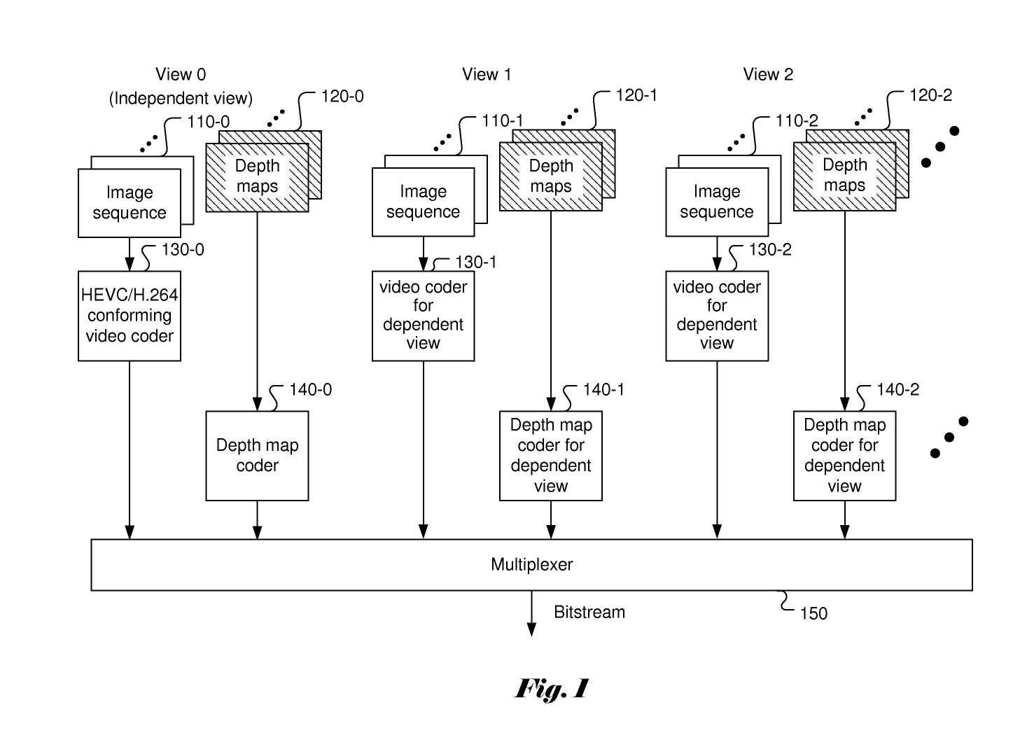

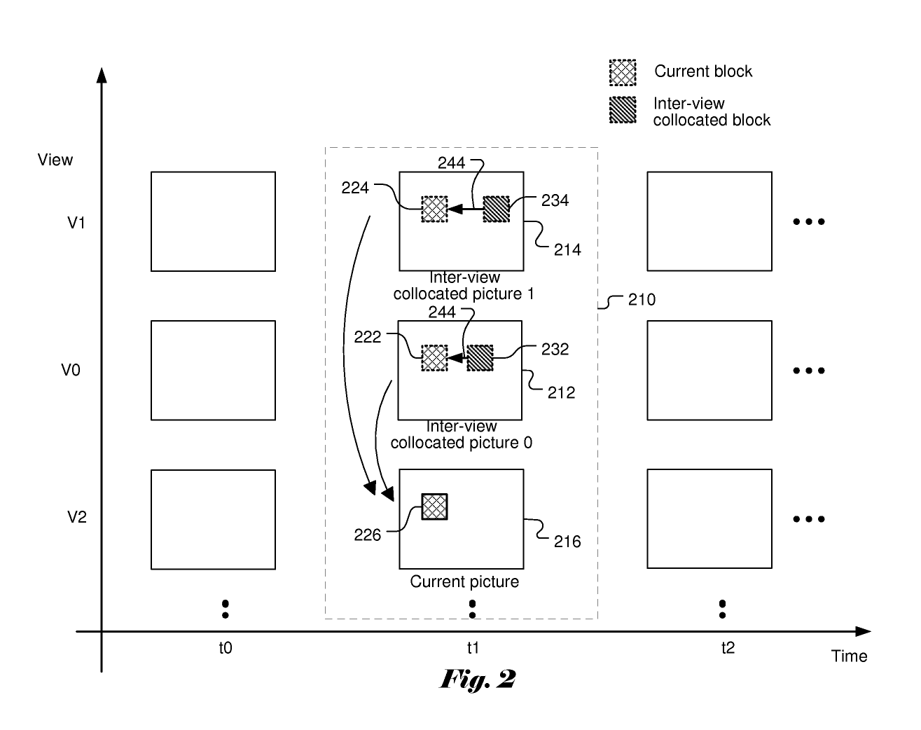

### DETAILED DESCRIPTION

In order to take advantage of high coding efficiency due to motion vector prediction and disparity vector prediction (MVP/DVP) while avoiding the high computational complexity, embodiments according to the present invention utilize simplified inter-view motion vector prediction and disparity vector prediction. The particular examples for inter-view motion vector prediction and disparity vector prediction illustrated hereinafter should not be construed as limitations to the present invention. A person skilled in the art may use modifications to the prediction methods to practice the present invention without departing from the spirit of the present invention.

In the existing approach (i.e., HTM3.1) to Merge inter-view MVP/DVP derivation, all motion vectors (MVs) or disparity vectors (DVs) of corresponding blocks in the previously coded views can be added as inter-view candidates even if the inter-view pictures are not in the reference picture list of current picture. In the following description, motion vector prediction will be always used as an example for the derivation of Merge inter-view candidate. However, a person skilled in the art may extend the derivation of Merge inter-view candidate to disparity vector prediction. In the present invention, derivation of inter-view candidate (i.e., the MVP candidate or the DVP candidate) is constrained in order to provide better management of decoded picture. For example, the constraints may only allow the MVs of the inter-view pictures that are in the reference picture lists (List 0 or List 1) or in the decoded picture buffer of the current picture be used for deriving inter-view candidate. In another example, the constraints may only allow one inter-view picture be used to derive inter-view candidate. In yet another example, the constraint may only allow the MVs of the inter-view pictures in a base view (independent view) be used for deriving the inter-view candidate. These constraints can be applied individually or jointly.

When applying the above constraints jointly, additional constraints or features may be applied. For example, when the first and the second constraints are applied together, the following further constraints or features can be applied to select the designated inter-view reference picture for deriving inter-view candidate. In the first example of further constraint, only the inter-view reference picture in List 0 with the smallest reference picture index can be used for deriving the inter-view candidate. If no inter-view reference picture exists in List0, only the inter-view reference pictures in List 1 with the smallest reference picture index can be used for deriving the inter-view candidate. In the second example of further constraint, only the inter-view reference picture with the smallest view index can be used for deriving the inter-view candidate. In the third example of further constraint, one syntax element (e.g. view ID) can be used to indicate which inter-view reference picture is used for deriving the inter-view candidate. In the fourth example of further constraint, one syntax element is signaled to indicate which reference picture list (i.e., List 0 or List 1) corresponds to the selected inter-view reference picture. Based on the fourth further constraint, only the inter-view reference picture with the smallest reference picture index can be used for deriving the inter-view candidate. Based on the fourth further constraint, one syntax element can be signaled to indicate which inter-view reference picture in the reference picture list is used for deriving the inter-view candidate.

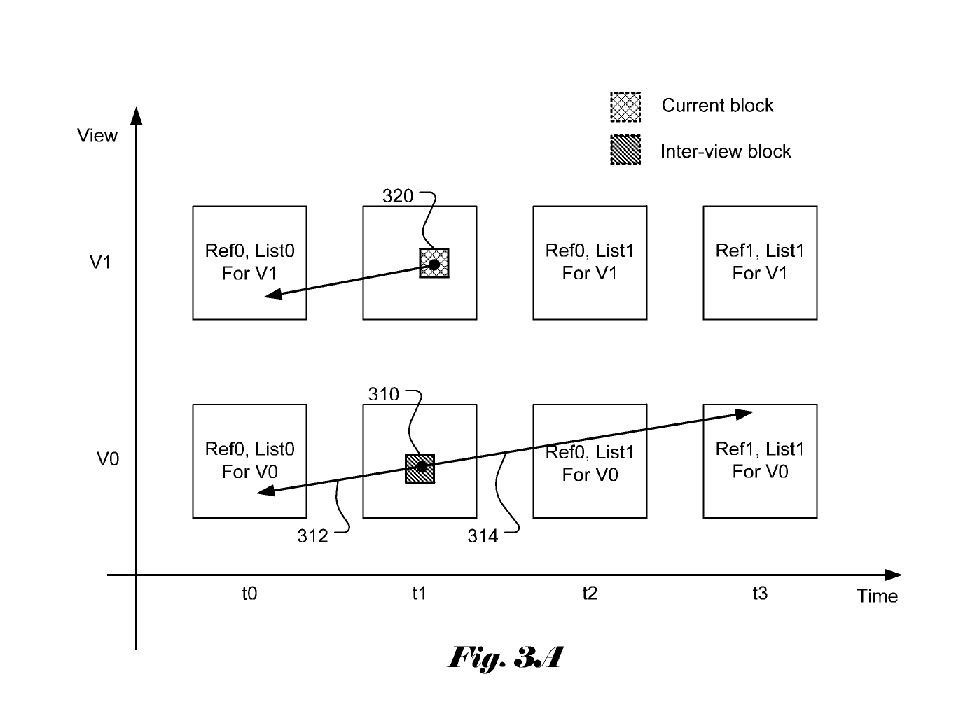

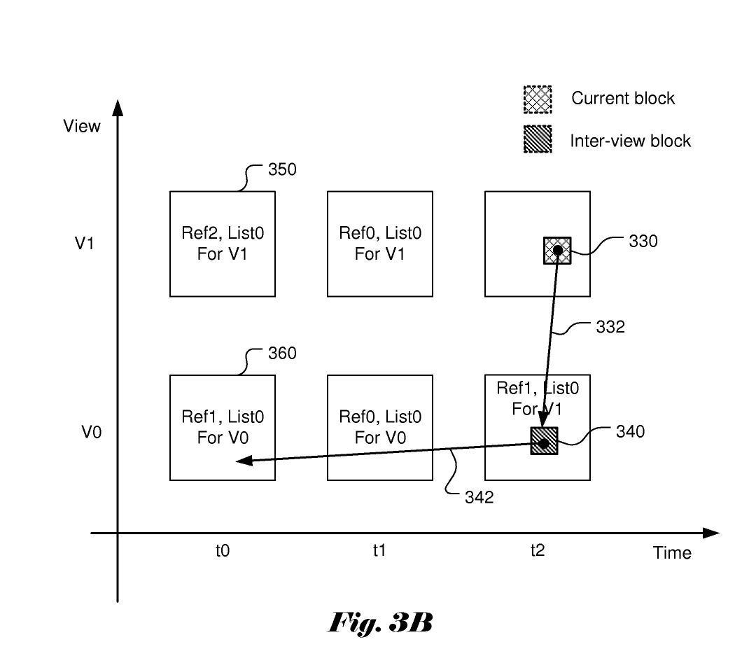

In HTM3.1, the derivation of Merge inter-view candidate is complex and some candidates may not be reasonable. FIG. 3 shows two examples where the candidate is unreasonable.

In FIG. 3A, the inter-view block (310) in V0 has two MVs (312 and 314). One MV points to the reference index 0 of List 0, and the other MV points to the reference index 1 of List 1. However, following the Algorithm 1 in current HTM3.1, only the MV pointing to the reference index 0 of List 0 is used for current block (320) in V1 as merge inter-view candidate and the MV pointing to reference index 1 of List 1 is not used.

In FIG. 3B, the inter-view block (340) in V0 has one MV (342) pointing to the reference index 1 of List 0. The inter-view picture in V0 is inserted in List 0 of current picture as a reference picture with reference index 1. After the inter-view picture in V0 is inserted in List 0, the reference index in List 0 will be changed as shown in FIG. 3B, where the corresponding reference picture Ref1 L0 for V0 becomes Ref2 L0 for V1. According to the Algorithm 1, the inter-view candidate of current block (330) is the disparity vector (332) pointing to reference index 1 of List 0 in V0. However, the MV of inter-view block in V0 is not used for current block in V1 since the disparity vector is used instead.

In order to avoid these unreasonable inter-view candidates, embodiments of the present invention use different Merge inter-view candidate derivation by imposing constraints on inter-view candidate selection as described in Algorithm 3:

Algorithm 3: Merge inter-view candidate derivation
1. Determine inter-view pictures used to derive the Merge inter-view candidate according to an embodiment of the present invention incorporating one or more constraints on inter-view candidate derivation as mentioned above.
2. For a given inter-view picture determined by step 1, derive the inter-view motion candidate according to Algorithm 4.
3. If the inter-view motion candidate is available, then go to step 5;

Else if a next inter-view picture is available, then go to step 2;

Else go to step 4.
4. Derive the inter-view disparity vector candidate according to Algorithm 5 or Algorithm 6.
5. Done.

Algorithm 4: Merge inter-view motion candidate derivation

The motion information, including MVs, prediction direction (L0, L1, or Bi-pred), and reference pictures of the inter-view block can all be used for the current block. Exemplary processing steps according to an embodiment are shown as follows:
1. Assume that the viewId of inter-view picture is Vi and the viewId of the current picture is Vc.
2. For each reference list of the given inter-view picture with view Vi, if
   there is a reference picture ColRef with view Vi used for Inter prediction of the inter-view block; and
   view Vc of the ColRef is also in the same reference list of the current picture, then
   the reference picture and MV of the current block in this list are set as view Vc of the ColRef and the MV of inter-view block pointing to view Vi of the ColRef respectively; and
   the inter-view motion candidate of this reference list of the current block is marked as available.
3. If the inter-view motion candidate of List 0 or List 1 is available, then the inter-view motion candidate of the current block is marked as available,

Else the inter-view motion candidate of the current block is marked as unavailable.

In Algorithm 4 step 2, if view Vc of the ColRef is not in the same reference list of the current picture, the inter-view motion vector candidate of this reference list of the current block will be marked as unavailable. However, there are some alternative methods as follows. For example, if view Vc of the ColRef is not in the same reference list of the current picture, the MV of the inter-view block pointing to the ColRef is scaled to the target reference picture of the current block, and the scaled MV is set as MV of the current block, wherein the target picture can be the temporal reference picture with the smallest reference picture index, the temporal reference picture which is the majority of the temporal reference pictures of spatially neighboring blocks, or the temporal reference picture which has the smallest POC (picture order count) distance to the ColRef.

Algorithm 5: Merge inter-view disparity vector candidate derivation

For each reference list of the current picture:

the reference picture which is an inter-view reference picture with the smallest reference index is used as the reference picture of the list of the current block; and

the disparity vector derived from the depth map or a global disparity vector is used as the MV of the current block.

Algorithm 6: Merge inter-view disparity vector candidate derivation
1. For reference List 0 of the current picture, the reference picture which is an inter-view reference picture with the smallest reference index is used as the reference picture of List 0 of the current block, and the disparity vector derived from the depth map or a global disparity vector is used as the MV of the current block.
2. If the MV and the reference picture of List 0 of the current block are valid and available, then go to step 4;

Else, go to step 3.
3. For reference List 1 of the current picture, the reference picture which is an inter-view reference picture with the smallest reference index is used as the reference picture of List 1 of the current block, and the disparity vector derived from the depth map or a global disparity vector is used as the MV of the current block.
4. Done.

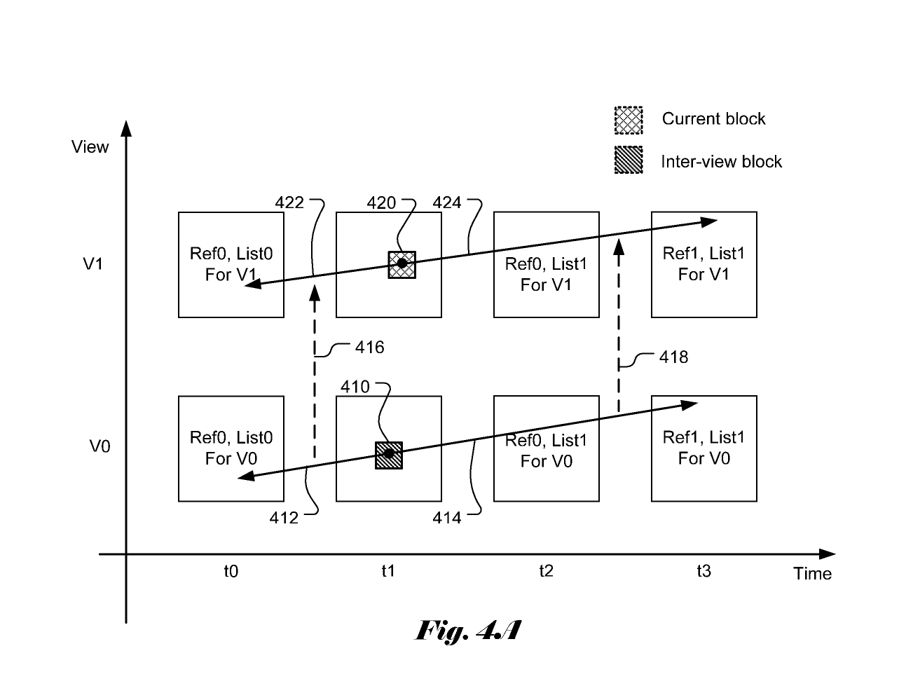

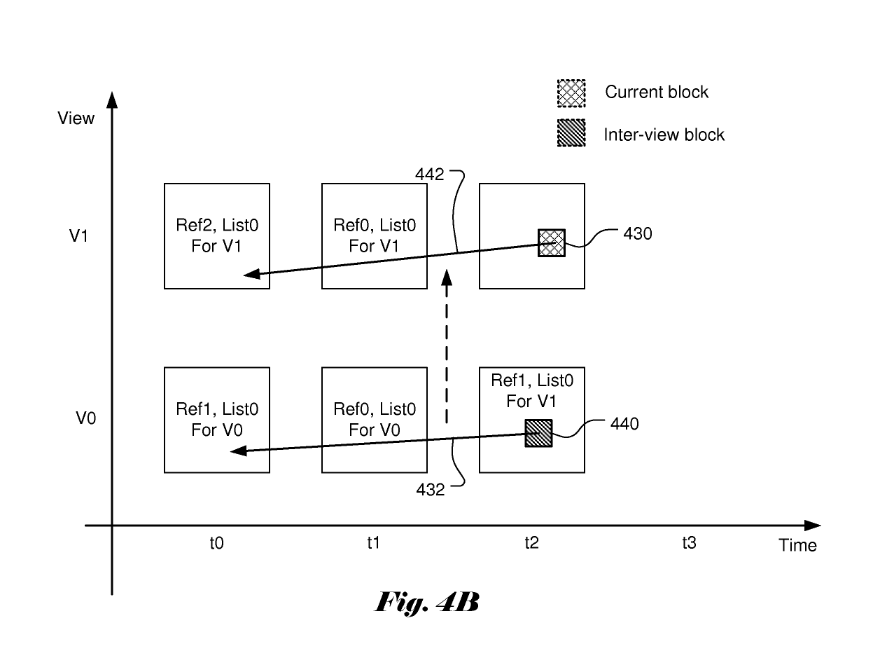

For a system incorporating an embodiment of the present invention as described in Algorithm 3, the Merge inter-view candidate derivation for the cases as shown in FIG. 3 is modified as shown in FIG. 4. FIG. 4A illustrates an example of inter-view candidate derivation based on Algorithm 3 while the derivation based on the conventional algorithm will lead to the result shown in FIG. 3A. According to step 1 of Algorithm 3, V0 is used to derive the inter-view candidate. According to step 2 (i.e., using Algorithm 4 to derive the inter-view motion candidate), inter-view block for list0 refidx0 of V0 has an MV (412). On the other hand, the V1 of this ColRef (i.e., L0 Ref0 of V0) is also in list0 of current block. Therefore, the MV (422) is re-used from V0 as inter-view candidate of L0 for V1. The same derivation is applied to L1 refidx1 of V0. The MV (414) associated with list1 refidx1 of V0 can be re-used for V1 as inter-view candidate MV (424). FIG. 4B illustrates another example of inter-view candidate derivation according to the present invention while the derivation based on the conventional algorithm will lead to the result shown in FIG. 3B. According to step 1 of Algorithm 3, V0 is used to derive the inter-view candidate. According to step 2 (i.e., using Algorithm 4 to derive the inter-view motion candidate), inter-view block for list0 refidx1 of V0 has an MV (432). On the other hand, the V1 of this ColRef (i.e., L0 Ref1 of V0) is also in list0 of current block. Therefore, the MV (442) is re-used from V0 as inter-view candidate of L0 for V1.

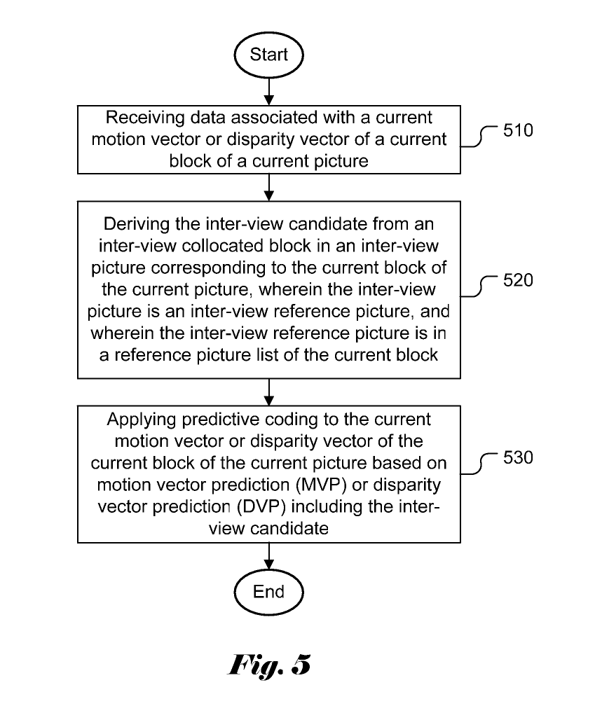

FIG. 5 illustrates an exemplary flowchart of a three-dimensional encoding or decoding system incorporating the constrained Merge inter-view candidate derivation according to an embodiment of the present invention. The system receives data associated with a current motion vector or disparity vector of the current block of the current picture as shown in step 510. For encoding, the data associated with the current motion vector or disparity vector of the current block may correspond to the current motion vector or disparity vector itself. For decoding, the data associated with the current motion vector or disparity vector of the current block may correspond to the coded current motion vector or disparity vector itself. The data may be retrieved from storage such as a computer memory, buffer (RAM or DRAM) or other media. The data may also be received from a processor such as a controller, a central processing unit, a digital signal processor or electronic circuits that derives the current motion vector or disparity vector for encoding or recovers the coded motion vector or disparity vector from a bitstream for decoding. The Merge inter-view candidate is derived from an inter-view collocated block in an inter-view picture corresponding to the current block of the current picture as shown in step 520, wherein the inter-view picture is an inter-view reference picture and the inter-view reference picture has a smallest reference picture index in a reference picture list of the current block or is in a base view. Predictive coding is then applied to the current motion vector or disparity vector of the current block of the current picture based on motion vector prediction (MVP) or disparity vector prediction (DVP) including the Merge inter-view candidate as shown in step 530. For predictive encoding, the inter-view MVP/DVP candidate may be the same as the current motion vector or disparity vector. In this case, Merge inter-view coding can be used so that the current motion vector or disparity vector may re-use motion information associated with the Merge inter-view candidate. For predictive decoding, if the coded current motion vector or disparity vector indicates the Merge inter-view mode is used for the current block, the current motion vector or disparity vector can be recovered using motion information associated with the MVP/DVP.

The flowchart shown above is intended to illustrate an example of inter-view prediction based on sub-block partition. A person skilled in the art may modify each step, re-arranges the steps, split a step, or combine steps to practice the present invention without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of deriving an inter-view candidate for a block in a picture for three-dimensional video coding, the method comprising:
receiving data associated with a current motion vector or disparity vector of a current block of a current picture;
deriving the inter-view candidate from an inter-view collocated block in an inter-view picture corresponding to the current block of the current picture, wherein the inter-view picture is an inter-view reference picture, and wherein the inter-view reference picture is in a reference picture list of the current block; and
applying predictive coding to the current motion vector or disparity vector of the current block of the current picture based on motion vector prediction (MVP) or disparity vector prediction (DVP) including the inter-view candidate.

2. The method of claim 1, wherein location of the inter-view collocated block is determined based on one disparity vector derived from a depth map or a global disparity vector.

3. The method of claim 1, wherein motion information of the inter-view collocated block is re-used directly by the current block of the current picture, wherein the motion information comprises motion vectors, prediction direction, reference pictures of the inter-view collocated block, and any combination thereof, and wherein the prediction direction includes reference picture List 0, reference picture List 1 or bi-prediction.

4. The method of claim 3, wherein the motion information is scaled to a target reference picture of the current block if the reference picture of the inter-view collocated block is not in any reference picture list of the current block.

5. The method of claim 4, wherein the target reference picture is a temporal reference picture with a smallest reference picture index.

6. The method of claim 4, wherein the target reference picture is a temporal reference picture corresponding to a majority of the temporal reference pictures of spatially neighboring blocks of the current block.

7. The method of claim 4, wherein the target reference picture is a temporal reference picture with a smallest POC (Picture Order Count) distance to the reference picture of the inter-view collocated block.

8. The method of claim 1, wherein one disparity vector of the inter-view collocated block is used as the motion vector of the inter-view collocated block if motion information of the inter-view collocated block is invalid for the current block.

9. The method of claim 1, wherein only one inter-view picture is used to derive the inter-view candidate.

10. The method of claim 9, wherein only a first inter-view reference picture in reference picture List 0 with a first smallest reference picture index is used to derive the inter-view candidate; and wherein only a second inter-view reference picture in reference picture List 1 with a second smallest reference picture index is used to derive the inter-view candidate if no inter-view reference picture exists in reference picture List 0.

11. The method of claim 9, wherein only the inter-view reference picture with a smallest view index is used to derive the inter-view candidate.

12. The method of claim 9, wherein one syntax element is used to indicate which inter-view reference picture is used to derive the inter-view candidate.

13. The method of claim 9, wherein one syntax element is signaled to indicate which reference picture list corresponding to the inter-view reference picture is used to derive the inter-view candidate.

14. The method of claim 9, wherein only the inter-view reference picture with a smallest reference picture index is used to derive the inter-view candidate.

15. The method of claim 14, wherein one syntax element is signaled to indicate which inter-view reference picture in the reference picture list is used to derive the inter-view candidate.

16. The method of claim 1, wherein only the inter-view picture in a decoded picture buffer is used to derive the inter-view candidate.

17. The method of claim 1, wherein only the inter-view picture in a base view is used to derive the inter-view candidate.

18. The method of claim 1, wherein, for three-dimensional video encoding, the data associated with the current motion vector or disparity vector corresponds to the current motion vector or disparity vector, and said applying predictive coding to the current motion vector or disparity vector of the current block generates a coded current motion vector or disparity vector of the current block.

19. The method of claim 1, wherein, for three-dimensional video decoding, the data associated with the current motion vector or disparity vector corresponds to a coded current motion vector or disparity vector, and said applying predictive coding to the current motion vector or disparity vector of the current block generates a recovered current motion vector or disparity vector of the current block.

20. An apparatus for deriving inter-view candidate for a block in a picture for three-dimensional video coding, the apparatus comprising:
electronic circuits, wherein the electronic circuits are configured,
to receive data associated with a current motion vector or disparity vector of a current block of a current picture;
to derive the inter-view candidate from an inter-view collocated block in an inter-view picture corresponding to the current block of the current picture, wherein the inter-view picture is an inter-view reference picture, and wherein the inter-view reference picture is in a reference picture list of the current block; and
to apply predictive coding to the current motion vector or disparity vector of the current block of the current picture based on motion vector prediction (MVP) or disparity vector prediction (DVP) including the inter-view candidate.
